(19) United States
(12) Patent Application Publication
(10) Pub. No.: US 2026/0339756 A1
(43) Pub. Date: Oct. 29, 2026

(54) GENERATING API AND EVENTS DOCUMENTATION FROM SCHEMAS

(71) Applicant: SAP SE, Walldorf (DE)

(72) Inventors: Michelle Kemp-Nordell, Kadima (IL); Sapna Chandrashekar Bejai, Leinfelden-Echterdingen (DE)

(21) Appl. No.: 19/187,038

(22) Filed: Apr. 23, 2025

(51) Int. Cl. G06F 9/54; G06F 40/226

(52) U.S. Cl. CPC G06F 9/54; G06F 40/226

(57) ABSTRACT

Different techniques and generative models of generative AI (GenAI) are used to automate the process of writing descriptions for structured objects, such as APIs and events. A GenAI system generates descriptions from schemas and uses the generated descriptions to modify or create structured documents that include documentation for the APIs or events described by the schemas. The descriptions may be generated using large language models (LLMs) with integrated knowledge graphs. A knowledge graph contains links to backend systems that provide the LLM with additional information that helps improve results and reduce hallucinations. The descriptions may be validated to ensure that they follow standards and guidelines, use correct grammar and spelling, or any suitable combination thereof. A bulk user interface may also be provided. The bulk user interface allows the user to enter paths for a batch of multiple APIs or events. In response, the system begins generating documentation for all of the identified schema files.

### TECHNICAL FIELD

The subject matter disclosed herein generally relates to documentation for application programming interfaces (APIs) and events, and more specifically, to automatically generating such documentation from schema files.

### BACKGROUND

Generative artificial intelligence (GenAI), including large language models (LLMs), uses neural networks to generate output. An LLM is an advanced AI algorithm trained on massive amounts of text data to learn the rules, patterns, and relationships of language. LLMs are capable of processing and generating text. Users interact with generative AI applications by providing prompts.

The output from the GenAI may include hallucinations. Hallucinations are incorrect, nonsensical, or fabricated responses provided by an LLM. Hallucinations often appear plausible and convincing, but they are not grounded in reality.

Structured objects used in programming such as APIs and events are commonly documented using formal specifications. Developers often maintain this documentation as part of maintaining related source code.

### BRIEF DESCRIPTION OF THE DRAWINGS

FIG. 1 shows a network diagram illustrating an example network environment suitable for automatically generating API and events documentation from schemas.

FIG. 2 shows a block diagram of an LLM server, suitable for automatically generating API and events documentation from schemas.

FIG. 3 is a block diagram of a neural network, suitable for use as an LLM for automatically generating API and events documentation from schemas, according to some example embodiments.

FIG. 4 illustrates an example undocumented schema, according to some example embodiments.

FIG. 5 illustrates a user interface for use in automatically generating API and events documentation from schemas, according to some example embodiments.

FIG. 6 illustrates a user interface for use in automatically generating API and events documentation from schemas, according to some example embodiments.

FIG. 7 illustrates a user interface for use in automatically generating API and events documentation from schemas, according to some example embodiments.

FIG. 8 illustrates a user interface for use in automatically generating API and events documentation from schemas, according to some example embodiments.

FIG. 9 illustrates a user interface for use in automatically generating API and events documentation from schemas, according to some example embodiments.

FIG. 10 shows a flowchart of a method for automatically generating API and events documentation from schemas, according to some example embodiments.

FIG. 11 shows a block diagram showing one example of a software architecture for a computing device.

FIG. 12 shows a block diagram of a machine in the example form of a computer system within which instructions may be executed for causing the machine to perform any one or more of the methodologies discussed herein.

### DETAILED DESCRIPTION

Example methods and systems are directed to automatic generation of API and events documentation from schemas. Structured objects used in programming such as APIs or events are commonly documented using formal specifications. Developers often maintain this documentation as part of the source code that implements the object itself and schema files that describe interfaces provided by the source code. The embedded documentation follows the same life cycle as the object it describes and can be easily extracted using common methods, conventions, and tools.

Unfortunately, manually embedded structured documentation is often inconsistently written and usually contains missing descriptions due to a lack of time, skills, knowledge, or even a decision that the documentation is not required. In many cases, parameter descriptions are written without checking if there are existing descriptions because these descriptions are maintained in multiple backend systems. As a result, descriptions for the same parameter in different APIs or events have minor differences that are confusing for users. Manual efforts involved in reviewing and revising documentation are time-consuming and inconsistent.

As described herein, generative AI (GenAI) technology is used to automate the process of writing descriptions for structured objects, such as APIs and events. A GenAI system may be implemented as a cloud-based, tool-agnostic add-on that can be added to a variety of software tools for modeling APIs and events. The tool may use a database to store interim documentation files before they are published.

The GenAI system generates descriptions from schemas and uses the generated descriptions to modify or create structured documents that include documentation for the APIs or events described by the schemas. The descriptions may be generated using LLMs with integrated knowledge graphs. A knowledge graph contains links to backend systems that provide the LLM with additional information that helps improve results and reduce hallucinations. The descriptions may be validated to ensure that they follow standards and guidelines, use correct grammar and spelling, or any suitable combination thereof.

In various example embodiments, the GenAI system generates descriptions for a new (undocumented) API or event, generates descriptions for an existing (at least partially documented) API or event, generates descriptions for a batch of APIs or events (new or existing), or any suitable combination thereof.

To create documentation for a new or existing API or event, a user accesses the GenAI system. For example, the user may log in using an email address and password. The GenAI system may present a user interface that includes a dashboard with a list of saved APIs and events. From the dashboard, the user may select a “New” option and provide a path to a schema file for an API or an event. For example, the path may be for an API schema file. The user interface may also allow the user to select an LLM, a knowledge graph, or both.

The GenAI system accesses the file using the provided path. The LLM, using the knowledge graph, finds existing descriptions, generates new descriptions, or any suitable combination thereof. The descriptions for parameters of the API or event are stored in an interim file. A validation tool is run against the interim file to identify and correct inconsistencies between the interim file and documentation standards and guidelines. The validation tool may also check for and correct grammar errors, spelling errors, or both. The validated file is moved to a staging area that allows the user to view and edit the documentation.

In some example embodiments, the LLM determines, from the knowledge graph, that a parameter has already been documented for multiple existing APIs or events using inconsistent language. A user interface may be presented that informs the user of the different documentation for the parameter and indicates a number of times that each unique description for the parameter has been used. The user is enabled to select one of the existing descriptions or provide a new description for the parameter.

In some example embodiments, the validation tool identifies problems but does not fix them. The user may be enabled to edit the generated documentation and informed of the detected problems. For example, the validation tool may identify a particular line in the documentation file and identify a particular problem located that the identified line. After the user edits the file, the validation tool may be run again, and the process repeated until no further errors are detected or the user accepts the documentation despite any detected problems.

The system may detect that a user has chosen to publish the documentation. In response, the documentation file is merged with the schema file and copied to the development system.

A bulk user interface may also be provided. The bulk user interface allows the user to enter paths for a batch of multiple APIs or events. In response, the system begins generating documentation for all of the identified schema files, either in parallel or in series. The user may be presented with editing options as the generation of documentation for each schema file completes, or only after generation of documentation for the entire batch is complete.

By using the systems and methods herein, documentation for APIs and events is improved with a time savings of at least a factor of ten over existing methods. Furthermore, by automatically comparing definitions of parameters in different schemas, consistency of descriptions is improved. Automatic validation of descriptions further improves adherence of documentations to standards.

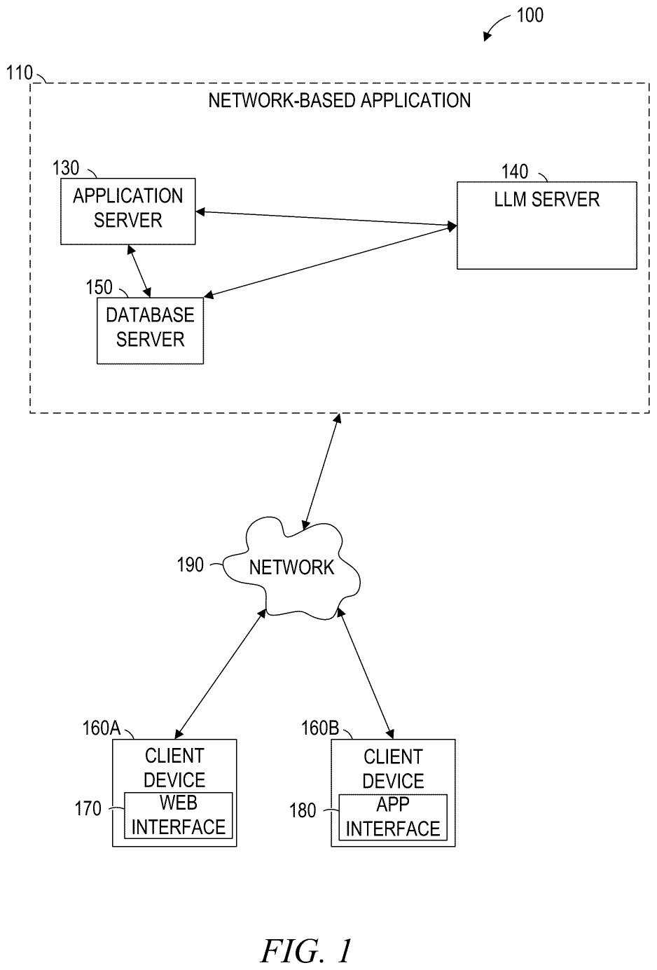

FIG. 1 shows a network diagram illustrating an example network environment 100 suitable for automatically generating API and events documentation from schemas. The network environment 100 includes a network-based application 110, client devices 160A and 160B, and a network 190. The network-based application 110 is implemented at a data center that comprises an application server 130 in communication with a database server 150 and an LLM server 140. The letter suffixes of reference numbers may be omitted when doing so does not raise ambiguity. For example, the client devices 160A-160B may be referred to collectively as “client devices 160.” Similarly, when the specific one of the client devices 160A-160B is not of particular import, “client device 160” may be referenced.

An application executing on the application server 130 may access data from the database server 150. The network-based application 110 may provide a user interface that allows a user to store or retrieve data from the database server 150. The user interface may be provided to the user via a web interface 170 (e.g., by generating a hypertext markup language [HTML] page at the server and sending it to a web browser to render on a display device) or an application interface 180 (e.g., by sending data via an API for processing by an application executing on the client device 160).

A software developer may create or modify the application executing on the application server 130. To aid in this process, the software developer consults documentation for APIs and events. The LLM server 140 may be used to automatically generate such documentation from the schema for the APIs and events being documented.

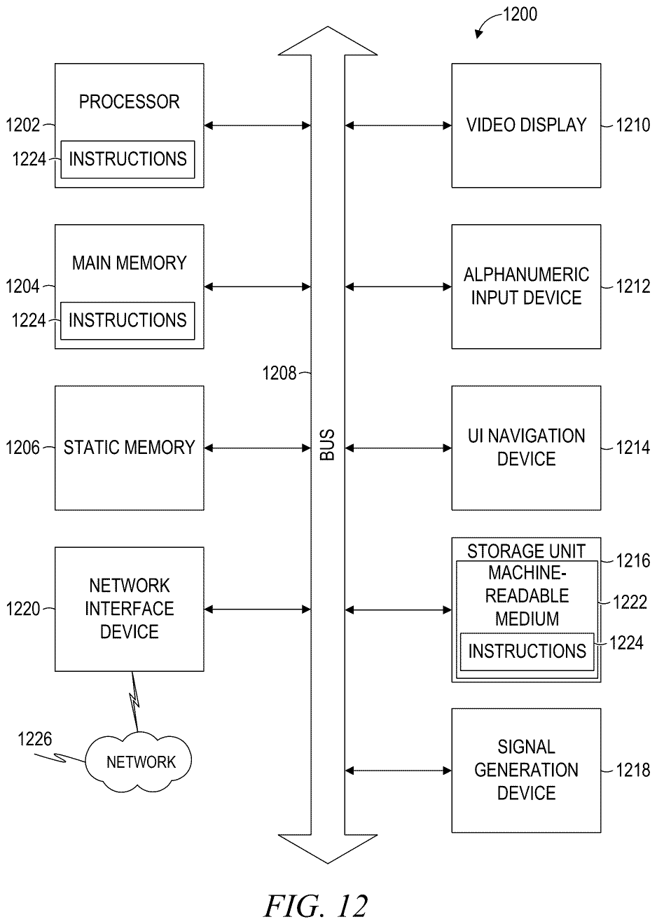

The application server 130, the database server 150, and the client devices 160A-160B may each be implemented in a computer system, in whole or in part, as described below with respect to FIG. 12. Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 12. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 130, the database server 150, and the client devices 160A-160B are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

Though FIG. 1 shows only one or two of each element (e.g., one LLM server 140, one application server 130, two client devices 160A and 160B, and the like), any number of each element is contemplated. For example, the application server 130 may be one of dozens or hundreds of active and standby servers and provide services to millions of client devices. Likewise, the LLM server 140 may be used by many application servers 130, and so on.

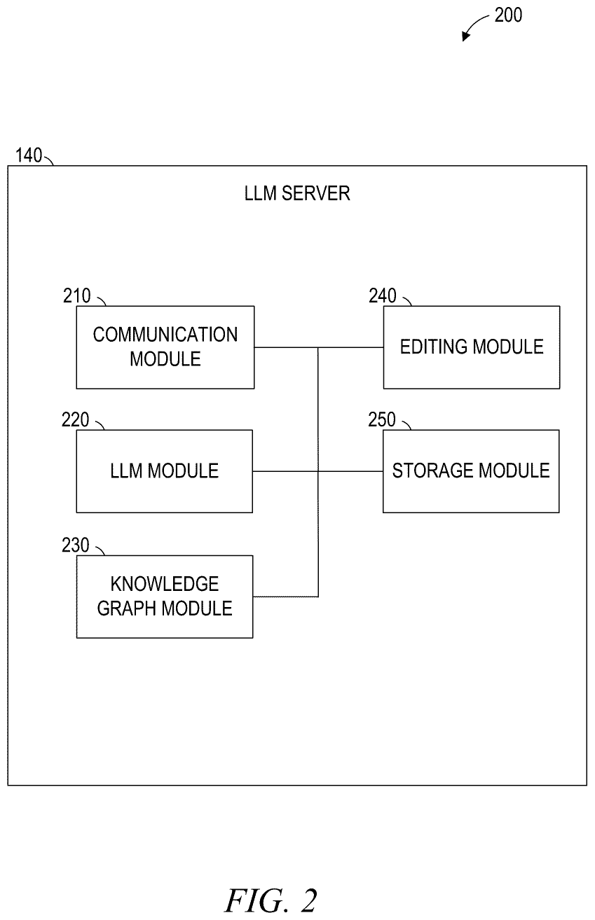

FIG. 2 shows a block diagram 200 of the LLM server 140, suitable for automatically generating API and events documentation from schemas. The LLM server 140 is shown as including a communication module 210, an LLM module 220, a knowledge graph module 230, an editing module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, modules described herein as being implemented within a single machine, database, or device may be distributed across multiple machines, databases, or devices.

The communication module 210 receives data sent to the LLM server 140 and transmits data from the LLM server 140. For example, the communication module 210 may receive, from the application server 130 or the database server 150, schema files for analysis.

The LLM module 220 generates documentation in response to a prompt that includes a schema. The documentation provides information for APIs or events described by the schema. Using well-constructed prompts, a general-purpose LLM may provide high-quality results without specialized training. The LLM module 220 may access a knowledge graph provided by the knowledge graph module 230. The knowledge graph shows data for, and relationships between, objects and methods used to implement APIs and events.

A user may be enabled to edit documentation generated by the LLM module 220 using the editing module 240. For example, a web interface may be presented on a display of the client device 160A. Edits to the documentation may be received via the network 190 and the documentation modified before being stored using the storage module 250.

Data, metadata, documents, instructions, or any suitable combination thereof may be stored and accessed by the storage module 250. For example, local storage of the LLM server 140, such as a hard drive, may be used. As another example, network storage may be accessed by the storage module 250 via the network 190.

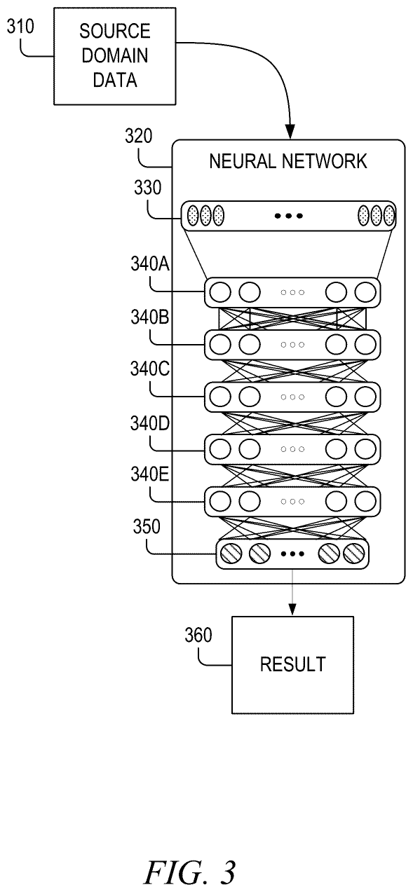

FIG. 3 is a block diagram of a neural network 320, suitable for use as an LLM for automatically generating API and events documentation from schemas, according to some example embodiments. The neural network 320 takes source domain data 310 as input and processes the source domain data 310 using an input layer 330; intermediate, hidden layers 340A, 340B, 340C, 340D, and 340E; and output layer 350 to generate a result 360.

A neural network, sometimes referred to as an artificial neural network, is a computing system based on consideration of biological neural networks of animal brains. Such systems progressively improve performance, which is referred to as learning, to perform tasks, typically without task-specific programming. For example, in image recognition, a neural network may be taught to identify images that contain an object by analyzing example images that have been tagged with a name for the object and, having learned the object and name, may use the analytic results to identify the object in untagged images.

A neural network is based on a collection of connected units called neurons, where each connection, called a synapse, between neurons can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

Each of the layers 330-350 comprises one or more nodes (or “neurons”). The nodes of the neural network 320 are shown as circles or ovals in FIG. 3. Each node takes one or more input values, processes the input values using zero or more internal variables, and generates one or more output values. The inputs to the input layer 330 are values from the source domain data 310. The output of the output layer 350 is the result 360. The intermediate layers 340A-340E are referred to as “hidden” because they do not interact directly with either the input or the output and are completely internal to the neural network 320. Though five hidden layers are shown in FIG. 3, more or fewer hidden layers may be used.

A model may be run against a training dataset for several epochs, in which the training dataset is repeatedly fed into the model to refine its results. In each epoch, the entire training dataset is used to train the model. Multiple epochs (e.g., iterations over the entire training dataset) may be used to train the model. In some example embodiments, the number of epochs is 10, 100, 500, or 1000. Within an epoch, one or more batches of the training dataset are used to train the model. Thus, the batch size ranges between one and the size of the training dataset, and the number of epochs is any positive integer value. The model parameters are updated after each batch (e.g., using gradient descent).

For self-supervised learning, the training dataset comprises self-labeled input examples. For example, a set of color images could be automatically converted to black-and-white images. Each color image may be used as a “label” for the corresponding black-and-white image and used to train a model that colorizes black-and-white images. This process is self-supervised because no additional information, outside of the original images, is used to generate the training dataset. Similarly, when text is provided by a user, one word in a sentence can be masked and the network trained to predict the masked word based on the remaining words.

Each model develops a rule or algorithm over several epochs by varying the values of one or more variables affecting the inputs to more closely map to a desired result, but as the training dataset may be varied, and is preferably very large, perfect accuracy and precision may not be achievable. A number of epochs that make up a learning phase, therefore, may be set as a given number of trials or a fixed time/computing budget, or may be terminated before that number/budget is reached when the accuracy of a given model is high enough or low enough or an accuracy plateau has been reached. For example, if the training phase is designed to run n epochs and produce a model with at least 95% accuracy, and such a model is produced before the nth epoch, the learning phase may end early and use the produced model, satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs-having reached a performance plateau-the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine an accuracy of the model in handling data that it has not been trained on. In a second example, a false positive rate or false negative rate may be used to evaluate the models after finalization. In a third example, a delineation between data clusters is used to select a model that produces the clearest bounds for its clusters of data.

The neural network 320 may be a deep learning neural network, a deep convolutional neural network (CNN), a recurrent neural network, a transformer neural network, or another type of neural network. A neuron is an architectural element used in data processing and artificial intelligence, particularly machine learning. A neuron implements a transfer function by which a number of inputs are used to generate an output. In some example embodiments, the inputs are weighted and summed, with the result compared to a threshold to determine if the neuron should generate an output signal (e.g., a 1) or not (e.g., a 0 output). The inputs of the component neurons are modified through the training of a neural network. One of skill in the art will appreciate that neurons and neural networks may be constructed programmatically (e.g., via software instructions) or via specialized hardware linking each neuron to form the neural network.

An example type of layer in the neural network 320 is a Long Short Term Memory (LSTM) layer. An LSTM layer includes several gates to handle input vectors (e.g., time-series data), a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input. Thus, the coefficients assign significance to inputs for the task the algorithm is trying to learn. These input-weight products are summed, and the sum is passed through what is called a node's activation function, to determine whether and to what extent that signal progresses further through the network to affect the ultimate outcome. A DNN uses a cascade of many layers of nonlinear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In training of a DNN architecture, a regression, which is structured as a set of statistical processes for estimating the relationships among variables, can include a minimization of a cost function. The cost function may be implemented as a function to return a number representing how well the neural network performed in mapping training examples to correct output. In training, if the cost function value is not within a predetermined range, based on the known training images, backpropagation is used, where backpropagation is a common method of training artificial neural networks that are used with an optimization method such as a stochastic gradient descent (SGD) method.

Use of backpropagation can include propagation and weight updates. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backwards, starting from the output, until each node has an associated error value, which roughly represents its contribution to the original output. Backpropagation can use these error values to calculate the gradient of the cost function with respect to the weights in the neural network. The calculated gradient is fed to the selected optimization method to update the weights to attempt to minimize the cost function.

In some example embodiments, the structure of each layer is predefined. For example, a convolution layer may contain small convolution kernels and their respective convolution parameters, and a summation layer may calculate the sum, or the weighted sum, of two or more values. Training assists in defining the weight coefficients for the summation.

One way to improve the performance of DNNs is to identify newer structures for the feature-extraction layers, and another way is by improving the way the parameters are identified at the different layers for accomplishing a desired task. For a given neural network, there may be millions of parameters to be optimized. Trying to optimize all these parameters from scratch may take hours, days, or even weeks, depending on the amount of computing resources available and the amount of data in the training set.

One of ordinary skill in the art will be familiar with several machine learning algorithms that may be applied with the present disclosure, including linear regression, random forests, decision tree learning, neural networks, DNNs, genetic or evolutionary algorithms, and the like. With the help of natural language processing (NLP) and advanced data pre-processing, a machine learning model (e.g., the neural network 320) can be trained on historical (existing) data (for instance, resource usage data) from the system to predict future data.

The transformer architecture processes an entire input at once rather than sequentially. For example, a recurrent neural network (RNN) processes words or sentences sequentially, with the output of the RNN treated as an input for each input after the first (thus the use of the word “recurrent” in the name). As a result, relationships between elements that are far apart in the input are difficult to detect. The transformer architecture receives a larger input and learns the interrelationships between the elements and the output using an attention mechanism. Since all elements are processed together, distance between the elements of the input does not affect the learning process. The output may still be generated sequentially, with the previous result (e.g., word for an LLM, pixel for an image-generating artificial intelligence, and the like) being provided as an input for determination of the next result.

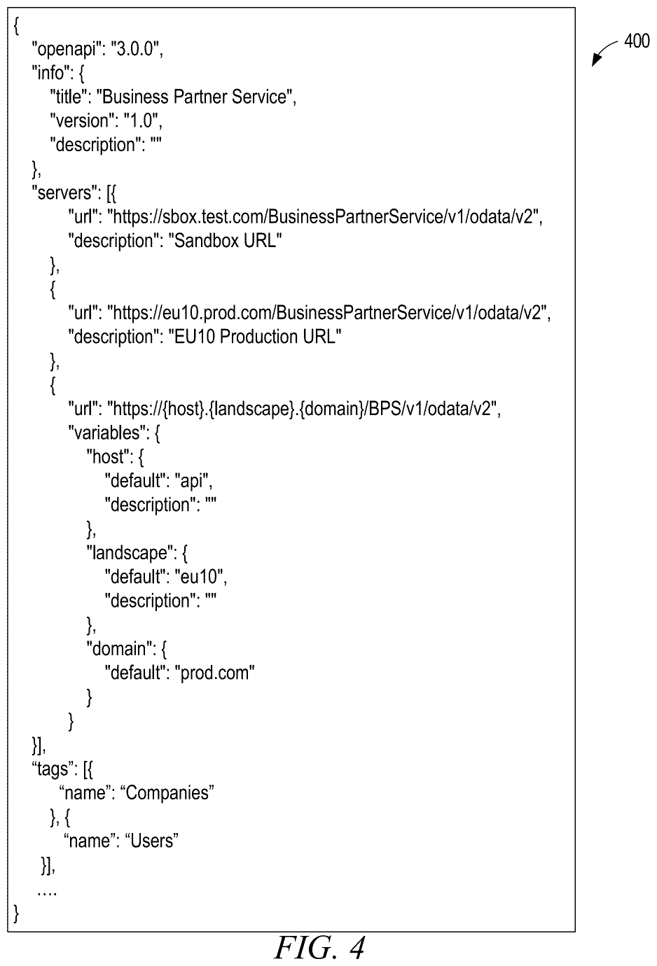

FIG. 4 illustrates an example undocumented schema 400, according to some example embodiments. The undocumented schema 400 defines an API. As can be seen, the “info” and “tags” attributes lack documentation entirely, either including an empty string as a value for their “description” or lacking a “description” attribute entirely. The “servers” attributes have descriptions for some elements, but not all. The undocumented schema 400 could be documented by a software developer manually editing the file (e.g., using a plain text editor) or by using a specialized user interface (e.g., a graphical user interface that provides discrete fields for the user to enter in description values). However, as discussed herein, the undocumented schema 400 may also be edited automatically to include documentation generated by a machine-learning model.

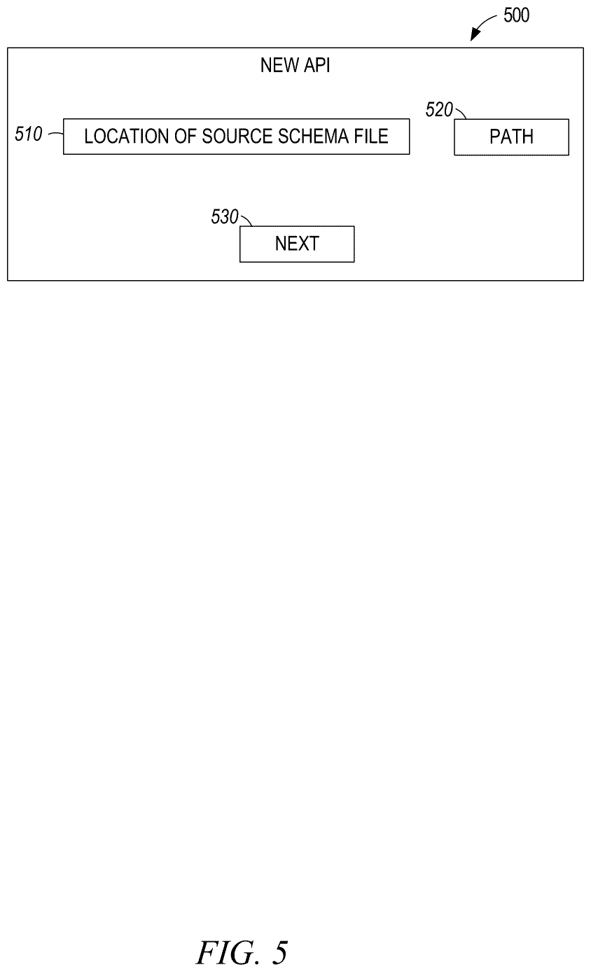

FIG. 5 illustrates a user interface 500 for use in automatically generating API and events documentation from schemas, according to some example embodiments. The user interface 500 is for documenting a new API and includes a label 510, an input field 520, and a button 530.

The label 510 indicates that the input field 520 receives a location of a source schema file. Thus, the user provides a path to the source schema file using the input field 520. Once the path is entered, the user submits the path by pressing the button 530.

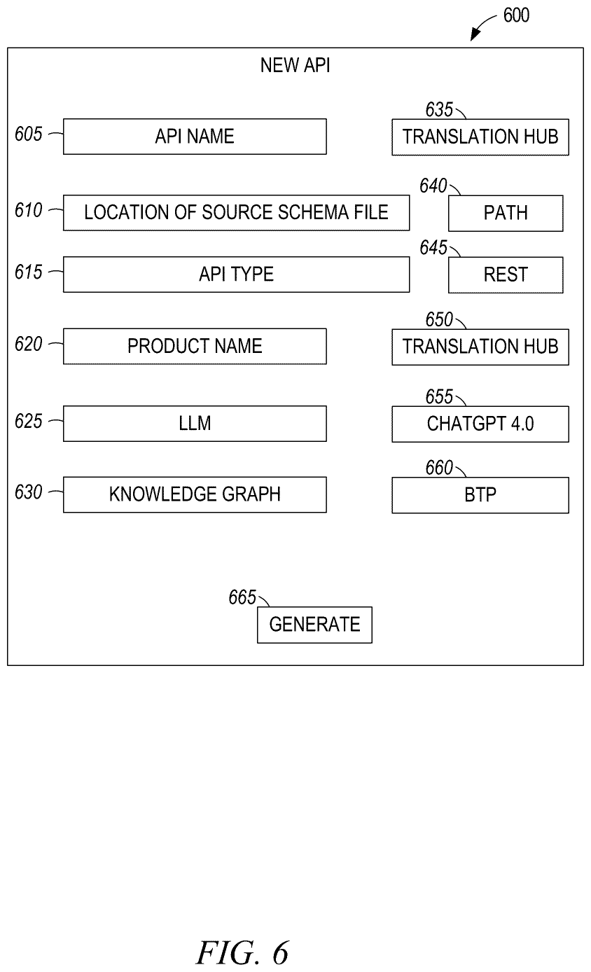

FIG. 6 illustrates a user interface 600 for use in automatically generating API and events documentation from schemas, according to some example embodiments. Like the user interface 500 of FIG. 5, the user interface 600 is also for documenting a new API. The user interface 600 includes labels 605, 610, 615, 620, 625, and 630; input fields 635, 640, 645, 650, 655, and 660; and a button 665. The user interface 600 may be presented after the user interface 500, with the input fields 635-650 populated based on information in the source schema file. In response to detecting user modification of values of the input fields 635-650, the source schema file may be modified by the application server 130 or the LLM server 140 (both of FIG. 1).

The user may select an LLM to use for generating documentation via the input field 655. The selected LLM may be one of multiple available LLMs. In the example of FIG. 6, the selected LLM is ChatGPT 4.0. A knowledge graph that includes information about APIs and events related to the source schema being documented may be identified by the input field 660. The LLM may access one or more URLs, databases, text documents, or other data sources based on the identified knowledge graph and use the accessed information to guide the generation of the documentation.

The button 665 is operable to submit the values in the input fields 635-660 to the application server 130 or the LLM server 140 to cause generation of the documentation. In response to detection of operation of the button 665, a prompt is created for the selected LLM. In response to the prompt, the LLM generates documentation for the selected source schema files.

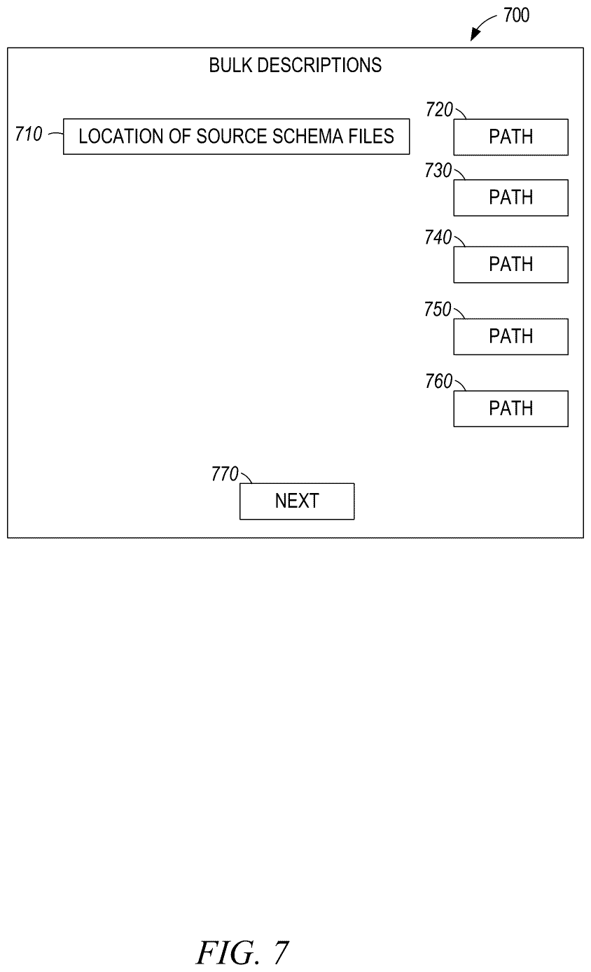

FIG. 7 illustrates a user interface 700 for use in automatically generating API and events documentation from schemas, according to some example embodiments. The user interface 700 is for documenting multiple APIs (i.e., for bulk processing). The user interface 700 includes a label 710; input fields 720, 730, 740, 750, and 760; and a button 770. The user interface 700 may be presented in place of the user interface 500 of FIG. 5, to allow a user to generate documentation for multiple APIs instead of for a single API.

The label 710 indicates that each of the input fields 720-760 receives a location of a source schema file. Thus, the user provides multiple paths to multiple source schema files using the input fields 720-760. Once the paths are entered, the user submits the paths by pressing the button 770.

After the bulk selection of multiple APIs or events to document, a list of generated API or event documentation files may be presented. Selection of one of the generated documentation files causes the generated documentation to be presented, allowing the user to review and modify the generated documentation for each API or event in turn.

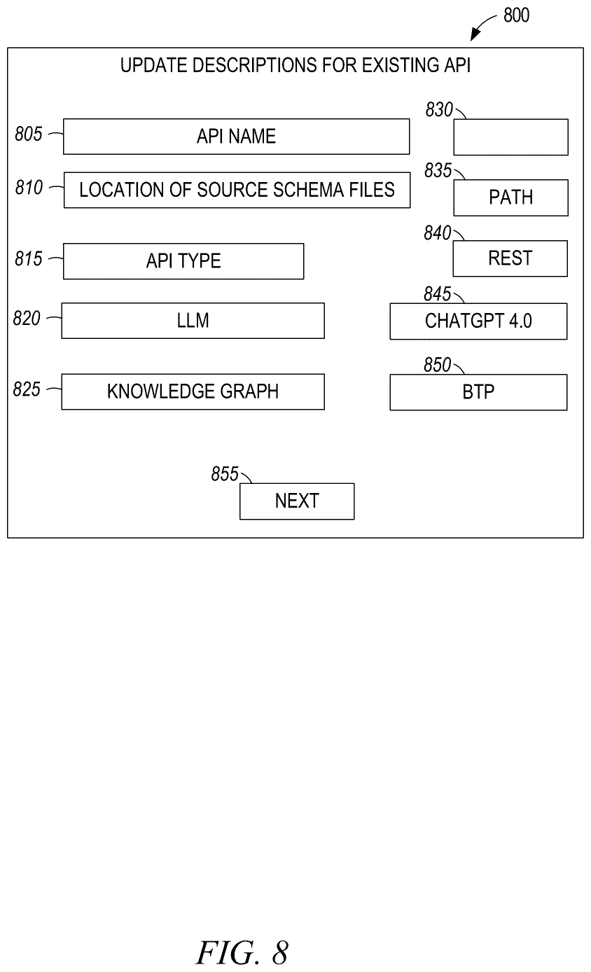

FIG. 8 illustrates a user interface 800 for use in automatically generating API and events documentation from schemas, according to some example embodiments. The user interface 800 is for updating descriptions for an existing API. This is in contrast to the user interfaces of FIGS. 5-7, which are for generating descriptions for new APIs. The user interface 800 includes labels 805, 810, 815, 820, and 825; input fields 830, 835, 840, 845, and 850; and a button 855.

The input field 830 receives a name of the API for which documentation is being updated. The input field 835 receives a path for the location of one or more source schema files for the API. A selection of an API type (e.g., REST, gRPC, or another API type) is made using the input field 840. The user may select an LLM to use for generating documentation via the input field 845. In the example of FIG. 8, the selected LLM is ChatGPT 4.0. A knowledge graph that includes information about APIs and events related to the source schema being documented may be identified by the input field 850. The LLM may access one or more URLs, databases, text documents, or other data sources based on the identified knowledge graph and used the accessed information to guide the generation of the documentation.

The knowledge graph identified by the input field 850 may be selected from multiple knowledge graphs, each corresponding to a different software product. The information provided in the knowledge graph includes existing descriptions for APIs and events used in the product. The LLM can search the existing descriptions to aid in description generation for the API identified by the input fields 830 and 835. This information may also help the LLM in reducing hallucinations.

The button 855 is operable to submit the values in the input fields 830-850 to the application server 130 or the LLM server 140 to cause generation of the documentation. In response to detection of operation of the button 855, a prompt is created for the selected LLM. In response to the prompt, the LLM updates documentation for the selected source schema files.

The prompt may comprise multiple parts. For example, a first part of the prompt may inform the LLM of a desired length of a short text (e.g., a maximum of 250 characters). A second part of the prompt may inform the LLM of a desired length of a description (e.g., one to three paragraphs). A third part of the prompt may provide descriptions for parameters. A fourth part of the prompt may ask the LLM to generate the short text and description. A fifth part of the prompt may provide descriptions of error messages to the LLM.

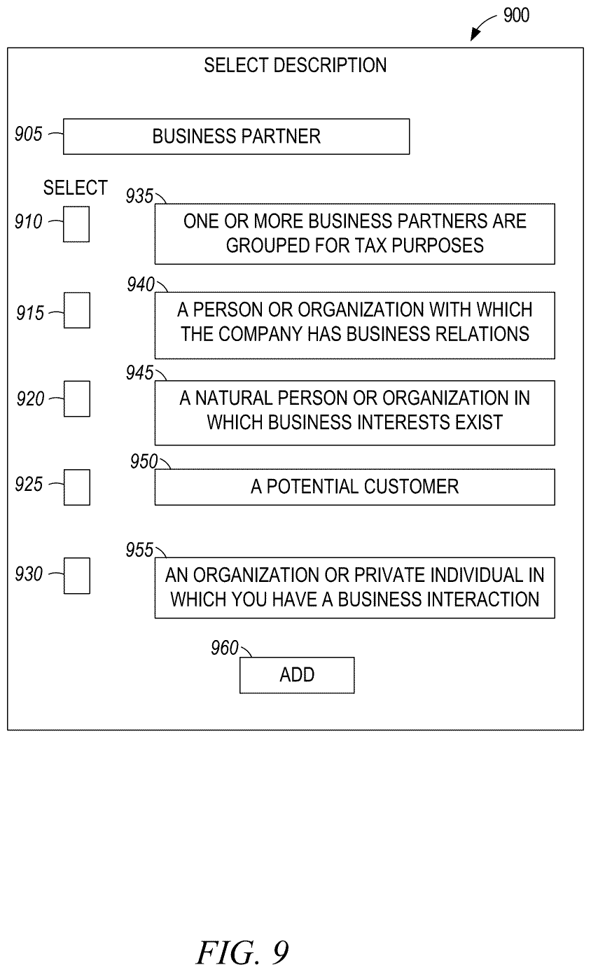

FIG. 9 illustrates a user interface 900 for use in automatically generating API and events documentation from schemas, according to some example embodiments. The user interface 900 includes a parameter name 905; options 910, 915, 920, 925, and 930; descriptions 935, 940, 945, 950, and 955; and a button 960. The user interface 900 may be displayed after one or more of the user interfaces of FIGS. 5-8, to allow a user to select one of several possible descriptions for an element of an API or event.

For example, the LLM server 140 of FIG. 1 may search through a knowledge graph identified by the input field 660 of FIG. 6 and find that several existing APIs or events have documentation for the parameter name 905. The existing documentation may be presented as descriptions 935-955. Accordingly, the user interface 900 may be presented to allow the user to select which of the descriptions 935-955 should be used. The user selects one of the options 910-930, each of which corresponds to a different one of the descriptions 935-955. In response to detecting operation of the button 960, the LLM server 140 modifies the documentation to use the description 935-955 corresponding to the selected one of the options 910-930.

In various example embodiments, additional information may be shown in the user interface 900. For example, the existing descriptions may be shown along with information about the existing systems that use each description, how many times each description has been used, or any suitable combination thereof.

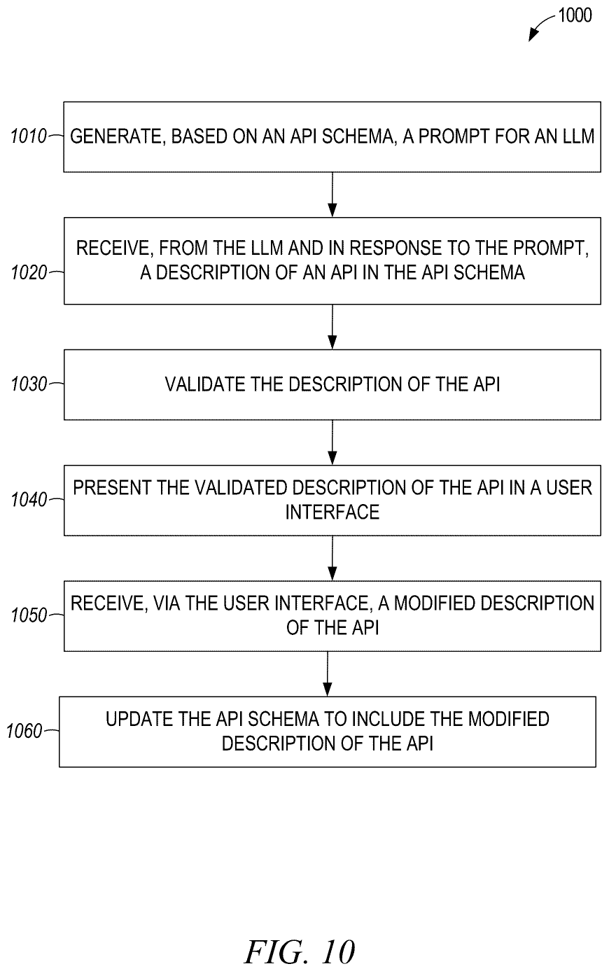

FIG. 10 shows a flowchart of a method 1000 for automatically generating API and events documentation from schemas, according to some example embodiments. By way of example and not limitation, the method 1000 is described as being performed by the application server 130 and the LLM server 140 of FIG. 1, using the modules of FIG. 2, the neural network of FIG. 3, the schema of FIG. 4, and the user interfaces of FIGS. 5-9. The method 1000 includes operations 1010, 1020, 1030, 1040, 1050, and 1060.

In operation 1010, the application server 130 generates, based on an API schema, a prompt for an LLM of the LLM server 140. For example, the prompt may instruct an LLM provided by the LLM module 220 to generate a description for elements of the API schema and include the API schema as part of the prompt. The API schema may be in any suitable format, such as OData, REST, or GraphQL. The API schema may be accessed based on user input received via one of the user interfaces of FIGS. 5-8, each of which allows a user to provide a path to an API schema. The prompt may be further based on a user-selected knowledge graph. For example, a root URL for documentation of a knowledge graph may be provided to the LLM, along with a tool that allows the LLM to access the URL and related documents.

The application server 130 receives, from the LLM and in response to the prompt, a description of an API in the API schema (operation 1020). For example, if the schema 400 of FIG. 4 is provided to the LLM as part of the prompt, the response from the LLM may include descriptions for the API itself (e.g., in the “info” field), for parameters (e.g., the “servers” parameter), for possible values of parameters (e.g., individual URL values for the “servers” parameter), for variables used in forming parameters (e.g., the “host,” “landscape,” and “domain,” variables used in forming valid URLs for the “servers” parameter), or any suitable combination thereof. The output from the LLM may be a modified version of the API schema, which may be stored as an interim schema file.

In operation 1030, the LLM server 140 validates the description of the API. The validation of the description may include grammar checking, spell checking, consistency checking, using a dedicated API metadata validation tool, or any suitable combination thereof. The validation process may include modifying the interim schema file (e.g., to correct spelling or grammar).

In this context, checking for an inconsistency in the description refers to determining if a description of an element of the API differs from other descriptions of elements having a same name. For example, the user interface 600 of FIG. 6 allows the user to identify a knowledge graph. The knowledge graph may include documentation for a number of existing APIs or events. The documentation in the knowledge graph may be accessed to identify any elements that have the same name as elements in the API being documented. If all descriptions for elements having the same name are identical, the descriptions are consistent. Otherwise, an inconsistency exists.

The editing module 240 presents, in operation 1040, the validated description of the API in a user interface. For example, one of the options 935-955 of the user interface 900 may include the validated description.

In operation 1050, the editing module 240 receives, via the user interface, a modified description of the API. For example, the user may select an option that corresponds to a different description. Alternatively, the user interface may include a text editor that allows the user to modify the description by inserting and deleting text.

In some example embodiments, the LLM server 140 validates the modified description of the API. Thus, a user may be asked to confirm or further revise the modified description if the modified description is inconsistent with existing descriptions, contains grammar or spelling errors, or the like.

The application server 130 updates the API schema to include the modified description of the API (operation 1060). For example, the schema 400 may be modified to include the modified description in the “description” member of the “info” field.

Thus, by use of the method 1000, an undocumented (or partially documented) API schema is modified to include descriptions for otherwise undocumented elements with less human involvement as compared to manual documentation processes. The method 1000 is described above as operating on an API schema, but applies equally well to an event schema. Thus, by repeated application of the method 1000, multiple API and event schemas may be automatically documented.

In view of the above-described implementations of subject matter this application discloses the following list of examples. One feature of an example in isolation or more than one feature of an example, taken in combination and, optionally, in combination with one or more features of one or more further examples are further examples also falling within the disclosure of this application.

Example 1 is a system for recommending data assets, the system comprising: one or more hardware processors; and a memory that stores instructions that, when executed by the one or more hardware processors, cause the one or more hardware processors to perform operations comprising: generating, based on an application programming interface (API) schema, a prompt for a large language model (LLM); receiving, from the LLM and in response to the prompt, a description of an API in the API schema; validating the description of the API; presenting the validated description of the API in a user interface; receiving, via the user interface, a modified description of the API; and updating the API schema to include the modified description of the API.

In Example 2, the subject matter of Example 1, wherein the validating of the description of the API comprises checking for an inconsistency in the description.

In Example 3, the subject matter of Examples 1-2, wherein the validating of the description of the API comprises checking for grammar and spelling errors in the description.

In Example 4, the subject matter of Examples 1-3, wherein the operations further comprise: validating the modified description of the API.

In Example 5, the subject matter of Examples 1-4, wherein the operations further comprise: receiving, via the user interface, a selection of the LLM from among a plurality of LLMs.

In Example 6, the subject matter of Examples 1-5, wherein the operations further comprise: receiving, via the user interface, a selection of a knowledge graph from among a plurality of knowledge graphs; wherein the generating of the prompt for the LLM is further based on the knowledge graph.

In Example 7, the subject matter of Examples 1-6, wherein the operations further comprise: generating, based on an event schema, a second prompt for the LLM; receiving, from the LLM and in response to the second prompt, a description of an event in the event schema; validating the description of the event; presenting the validated description of the event in the user interface; receiving, via the user interface, a modified description of the event; and updating the event schema to include the modified description of the event.

Example 8 is a non-transitory computer-readable medium that stores instructions that, when executed by one or more processors, cause the one or more processors to perform operations comprising: generating, based on an application programming interface (API) schema, a prompt for a large language model (LLM); receiving, from the LLM and in response to the prompt, a description of an API in the API schema; validating the description of the API; presenting the validated description of the API in a user interface; receiving, via the user interface, a modified description of the API; and updating the API schema to include the modified description of the API.

In Example 9, the subject matter of Example 8, wherein the validating of the description of the API comprises checking for an inconsistency in the description.

In Example 10, the subject matter of Examples 8-9, wherein the validating of the description of the API comprises checking for grammar and spelling errors in the description.

In Example 11, the subject matter of Examples 8-10, wherein the operations further comprise: validating the modified description of the API.

In Example 12, the subject matter of Examples 8-11, wherein the operations further comprise: receiving, via the user interface, a selection of the LLM from among a plurality of LLMs.

In Example 13, the subject matter of Examples 8-12, wherein the operations further comprise: receiving, via the user interface, a selection of a knowledge graph from among a plurality of knowledge graphs; wherein the generating of the prompt for the LLM is further based on the knowledge graph.

In Example 14, the subject matter of Examples 8-13, wherein the operations further comprise: generating, based on an event schema, a second prompt for the LLM; receiving, from the LLM and in response to the second prompt, a description of an event in the event schema; validating the description of the event; presenting the validated description of the event in the user interface; receiving, via the user interface, a modified description of the event; and updating the event schema to include the modified description of the event.

Example 15 is a method comprising: generating, based on an application programming interface (API) schema, a prompt for a large language model (LLM); receiving, from the LLM and in response to the prompt, a description of an API in the API schema; validating, by one or more processors, the description of the API; presenting the validated description of the API in a user interface; receiving, via the user interface, a modified description of the API; and updating the API schema to include the modified description of the API.

In Example 16, the subject matter of Example 15, wherein the validating of the description of the API comprises checking for an inconsistency in the description.

In Example 17, the subject matter of Examples 15-16, wherein the validating of the description of the API comprises checking for grammar and spelling errors in the description.

In Example 18, the subject matter of Examples 15-17 includes validating the modified description of the API.

In Example 19, the subject matter of Examples 15-18 includes receiving, via the user interface, a selection of the LLM from among a plurality of LLMs.

In Example 20, the subject matter of Examples 15-19 includes receiving, via the user interface, a selection of a knowledge graph from among a plurality of knowledge graphs; wherein the generating of the prompt for the LLM is further based on the knowledge graph.

Example 21 is an apparatus comprising means to implement any of Examples 1-20.

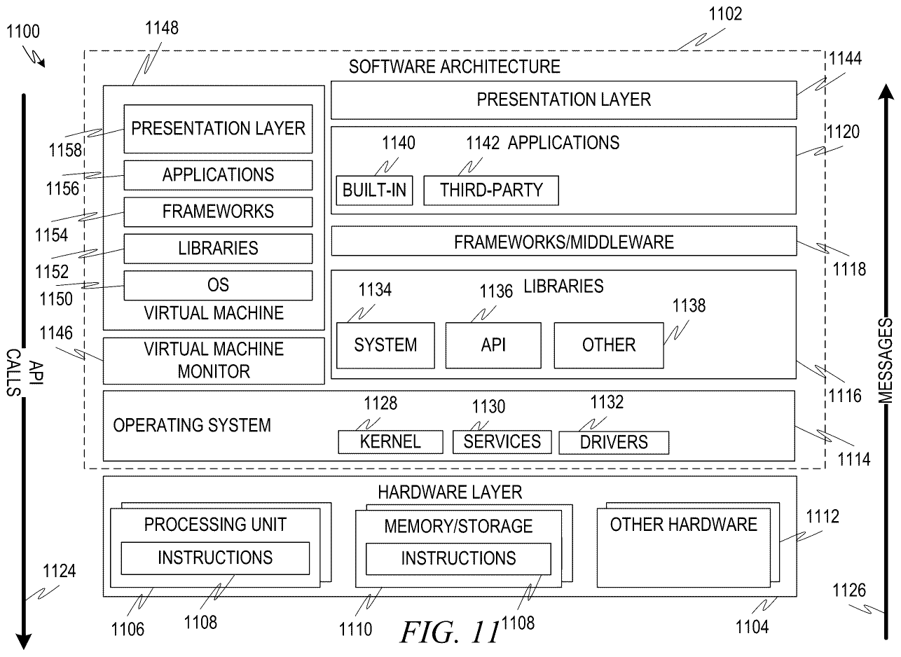

FIG. 11 shows a block diagram 1100 showing one example of a software architecture 1102 for a computing device. The software architecture 1102 may be used in conjunction with various hardware architectures, for example, as described herein. FIG. 11 is merely a non-limiting example of a software architecture, and many other architectures may be implemented to facilitate the functionality described herein. A representative hardware layer 1104 is illustrated and can represent, for example, any of the above referenced computing devices. In some examples, the hardware layer 1104 may be implemented according to the architecture of the computer system of FIG. 11.

The representative hardware layer 1104 comprises one or more processing units 1106 having associated executable instructions 1108. Executable instructions 1108 represent the executable instructions of the software architecture 1102, including implementation of the methods, modules, subsystems, and components, and so forth described herein and may also include memory and/or storage modules 1110, which also have executable instructions 1108. Hardware layer 1104 may also comprise other hardware 1112 which represents any other hardware of the hardware layer 1104. Examples of the other hardware 1112 include the hardware components shown in FIG. 12.

In the example architecture of FIG. 11, the software architecture 1102 may be conceptualized as a stack of layers where each layer provides particular functionality. For example, the software architecture 1102 may include layers such as an operating system 1114, libraries 1116, frameworks/middleware 1118, applications 1120, and presentation layer 1144. Operationally, the applications 1120 and/or other components within the layers may invoke API calls 1124 through the software stack and access a response, returned values, and so forth illustrated as messages 1126 in response to the API calls 1124. The layers illustrated are representative in nature and not all software architectures have all layers. For example, some mobile or special purpose operating systems may not provide a frameworks/middleware 1118 layer, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, the kernel 1128 may be responsible for memory management, processor management (e.g., scheduling), component management, networking, security settings, and so on. The services 1130 may provide other common services for the other software layers. In some examples, the services 1130 include an interrupt service. The interrupt service may detect the receipt of an interrupt and, in response, cause the software architecture 1102 to pause its current processing and execute an interrupt service routine (ISR) when an interrupt is accessed.

The drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 1116 may provide a common infrastructure that may be utilized by the applications 1120 and/or other components and/or layers. The libraries 1116 typically provide functionality that allows other software modules to perform tasks in an easier fashion than to interface directly with the underlying operating system 1114 functionality (e.g., kernel 1128, services 1130 and/or drivers 1132). The libraries 1116 may include system libraries 1134 (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks/middleware 1118 may provide a higher-level common infrastructure that may be utilized by the applications 1120 and/or other software components/modules. For example, the frameworks/middleware 1118 may provide various graphic user interface (GUI) functions, high-level resource management, high-level location services, and so forth. The frameworks/middleware 1118 may provide a broad spectrum of other APIs that may be utilized by the applications 1120 and/or other software components/modules, some of which may be specific to a particular operating system or platform.

The applications 1120 include built-in applications 1140 and/or third-party applications 1142. Examples of representative built-in applications 1140 may include, but are not limited to, a contacts application, a browser application, a book reader application, a location application, a media application, a messaging application, and/or a game application. Third-party applications 1142 may include any of the built-in applications as well as a broad assortment of other applications. In a specific example, the third-party application 1142 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1142 may invoke the API calls 1124 provided by the mobile operating system such as operating system 1114 to facilitate functionality described herein.

The applications 1120 may utilize built-in operating system functions (e.g., kernel 1128, services 1130 and/or drivers 1132), libraries (e.g., system libraries 1134, API libraries 1136, and other libraries 1138), and frameworks/middleware 1118 to create user interfaces to interact with users of the system. Alternatively, or additionally, in some systems, interactions with a user may occur through a presentation layer, such as presentation layer 1144. In these systems, the application/module “logic” can be separated from the aspects of the application/module that interact with a user.

Some software architectures utilize virtual machines. In the example of FIG. 11, this is illustrated by virtual machine 1148. A virtual machine creates a software environment where applications/modules can execute as if they were executing on a hardware computing device. A virtual machine is hosted by a host operating system (operating system 1114) and typically, although not always, has a virtual machine monitor 1146, which manages the operation of the virtual machine 1148 as well as the interface with the host operating system (i.e., operating system 1114). A software architecture executes within the virtual machine 1148 such as an operating system 1150, libraries 1152, frameworks/middleware 1154, applications 1156 and/or presentation layer 1158. These layers of software architecture executing within the virtual machine 1148 can be the same as corresponding layers previously described or may be different.

A computer system may include logic, components, modules, mechanisms, or any suitable combination thereof. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. One or more computer systems (e.g., a standalone, client, or server computer system) or one or more hardware processors may be configured by software (e.g., an application or application portion) as a hardware-implemented module that operates to perform certain operations as described herein.

A hardware-implemented module may be implemented mechanically or electronically. For example, a hardware-implemented module may comprise dedicated circuitry or logic that is permanently configured (e.g., as a special-purpose processor, such as a field programmable gate array [FPGA] or an application-specific integrated circuit [ASIC]) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Hardware-implemented modules may be temporarily configured (e.g., programmed), and each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiples of such hardware-implemented modules exist contemporaneously, communications may be achieved through signal transmission (e.g., over appropriate circuits and buses that connect the hardware-implemented modules). Multiple hardware-implemented modules are configured or instantiated at different times. Communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. The processor or processors may be located in a single location (e.g., within a home environment, an office environment, or a server farm), or the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

The systems and methods described herein may be implemented using digital electronic circuitry, computer hardware, firmware, software, a computer program product (e.g., a computer program tangibly embodied in an information carrier, e.g., in a machine-readable medium for execution by, or to control the operation of, data processing apparatus, e.g., a programmable processor, a computer, or multiple computers), or any suitable combination thereof.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites (e.g., cloud computing) and interconnected by a communication network. In cloud computing, the server-side functionality may be distributed across multiple computers connected by a network. Load balancers are used to distribute work between the multiple computers. Thus, a cloud computing environment performing a method is a system comprising the multiple processors of the multiple computers tasked with performing the operations of the method.

Operations may be performed by one or more programmable processors executing a computer program to perform functions by operating on input data and generating output. Method operations can also be performed by, and apparatus of systems may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. A programmable computing system may be deployed using hardware architecture, software architecture, or both. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out example hardware (e.g., machine) and software architectures that may be deployed.

FIG. 12 shows a block diagram of a machine in the example form of a computer system 1200 within which instructions 1224 may be executed for causing the machine to perform any one or more of the methodologies discussed herein. The machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit [CPU], a graphics processing unit [GPU], or both), a main memory 1204, and a static memory 1206, which communicate with each other via a bus 1208. The computer system 1200 may further include a video display unit 1210 (e.g., a liquid crystal display [LCD] or a cathode ray tube [CRT]). The computer system 1200 also includes an alphanumeric input device 1212 (e.g., a keyboard or a touch-sensitive display screen), a user interface (UI) navigation (or cursor control) device 1214 (e.g., a mouse), a storage unit 1216, a signal generation device 1218 (e.g., a speaker), and a network interface device 1220.

The storage unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, with the main memory 1204 and the processor 1202 also constituting a machine-readable medium 1222.

While the machine-readable medium 1222 is shown in FIG. 12 to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding, or carrying instructions 1224 for execution by the machine and that cause the machine to perform any one or more of the methodologies of the present disclosure, or that is capable of storing, encoding, or carrying data structures utilized by or associated with the instructions 1224. The term “machine-readable medium” shall accordingly be taken to include, but not be limited to, solid-state memories, and optical and magnetic media. Specific examples of machine-readable media include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

The instructions 1224 may further be transmitted or received over a communications network 1226 using a transmission medium. The instructions 1224 may be transmitted using the network interface device 1220 and any one of a number of well-known transfer protocols (e.g., hypertext transport protocol [HTTP]). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1224 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A system for recommending data assets, the system comprising:
one or more hardware processors; and
a memory that stores instructions that, when executed by the one or more hardware processors, cause the one or more hardware processors to perform operations comprising:
generating, based on an application programming interface (API) schema, a prompt for a large language model (LLM);
receiving, from the LLM and in response to the prompt, a description of an API in the API schema;
validating the description of the API;
presenting the validated description of the API in a user interface;
receiving, via the user interface, a modified description of the API; and
updating the API schema to include the modified description of the API.

2. The system of claim 1, wherein the validating of the description of the API comprises checking for an inconsistency in the description.

3. The system of claim 1, wherein the validating of the description of the API comprises checking for grammar and spelling errors in the description.

4. The system of claim 1, wherein the operations further comprise:
validating the modified description of the API.

5. The system of claim 1, wherein the operations further comprise:
receiving, via the user interface, a selection of the LLM from among a plurality of LLMs.

6. The system of claim 1, wherein the operations further comprise:
receiving, via the user interface, a selection of a knowledge graph from among a plurality of knowledge graphs;
wherein the generating of the prompt for the LLM is further based on the knowledge graph.

7. The system of claim 1, wherein the operations further comprise:
generating, based on an event schema, a second prompt for the LLM;
receiving, from the LLM and in response to the second prompt, a description of an event in the event schema;
validating the description of the event;
presenting the validated description of the event in the user interface;
receiving, via the user interface, a modified description of the event; and
updating the event schema to include the modified description of the event.

8. A non-transitory computer-readable medium that stores instructions that, when executed by one or more processors, cause the one or more processors to perform operations comprising:
generating, based on an application programming interface (API) schema, a prompt for a large language model (LLM);
receiving, from the LLM and in response to the prompt, a description of an API in the API schema;
validating the description of the API;
presenting the validated description of the API in a user interface;
receiving, via the user interface, a modified description of the API; and
updating the API schema to include the modified description of the API.

9. The non-transitory computer-readable medium of claim 8, wherein the validating of the description of the API comprises checking for an inconsistency in the description.

10. The non-transitory computer-readable medium of claim 8, wherein the validating of the description of the API comprises checking for grammar and spelling errors in the description.

11. The non-transitory computer-readable medium of claim 8, wherein the operations further comprise:
validating the modified description of the API.

12. The non-transitory computer-readable medium of claim 8, wherein the operations further comprise:
receiving, via the user interface, a selection of the LLM from among a plurality of LLMs.

13. The non-transitory computer-readable medium of claim 8, wherein the operations further comprise:
receiving, via the user interface, a selection of a knowledge graph from among a plurality of knowledge graphs;
wherein the generating of the prompt for the LLM is further based on the knowledge graph.

14. The non-transitory computer-readable medium of claim 8, wherein the operations further comprise:
generating, based on an event schema, a second prompt for the LLM;
receiving, from the LLM and in response to the second prompt, a description of an event in the event schema;
validating the description of the event;
presenting the validated description of the event in the user interface;
receiving, via the user interface, a modified description of the event; and
updating the event schema to include the modified description of the event.

15. A method comprising:
generating, based on an application programming interface (API) schema, a prompt for a large language model (LLM);
receiving, from the LLM and in response to the prompt, a description of an API in the API schema;
validating, by one or more processors, the description of the API;
presenting the validated description of the API in a user interface;
receiving, via the user interface, a modified description of the API; and
updating the API schema to include the modified description of the API.

16. The method of claim 15, wherein the validating of the description of the API comprises checking for an inconsistency in the description.

17. The method of claim 15, wherein the validating of the description of the API comprises checking for grammar and spelling errors in the description.

18. The method of claim 15, further comprising:
validating the modified description of the API.

19. The method of claim 15, further comprising:
receiving, via the user interface, a selection of the LLM from among a plurality of LLMs.

20. The method of claim 15, further comprising:
receiving, via the user interface, a selection of a knowledge graph from among a plurality of knowledge graphs;
wherein the generating of the prompt for the LLM is further based on the knowledge graph.
